(19) United States
(12) Patent Application Publication
(10) Pub. No.: US 2011/0168461 A1
(43) Pub. Date: Jul. 14, 2011

(54) BATTERY SYSTEM AND MOTOR VEHICLE

(75) Inventor: Joerge Meyer-Ebeling, Stuttgart (DE)

(73) Assignee: Dr. Ing. h.c.F. Porsche Aktiengesellschaft, Stuttgart (DE)

(21) Appl. No.: 12/984,654

(22) Filed: Jan. 5, 2011

(30) Foreign Application Priority Data
Jan. 14, 2010 (DE) 10 2010 004 549.7

(51) Int. Cl. B62D 25/08; B60L 11/18; H01M 10/00; H01M 10/02

(52) U.S. Cl. 180/65.1; 429/122; 429/149

(57) ABSTRACT

The invention relates to a battery system for driving an electric motor of a hybrid vehicle or of an electric vehicle. To improve the comfort, performance and/or the range of the vehicle, the battery system has an exchangeable component battery system (10).

### CROSS-REFERENCE TO RELATED APPLICATION

This application claims priority under 35 USC 119 to German Patent Application No. 10 2010 004 549.7, filed on Jan. 14, 2010, the entire disclosure of which is incorporated herein by reference.

### BACKGROUND OF THE INVENTION

1. Field of the Invention

The invention relates to a battery system having at least one battery for driving an electric motor of a hybrid vehicle or of an electric vehicle. The invention also relates to a motor vehicle having an electric motor that can be driven by a battery system. The invention further relates to a motor vehicle having a trunk compartment that is delimited at the bottom by a movable trunk compartment floor, and having an electric power source arranged beneath the trunk compartment floor.

2. Description of the Related Art

European patent specification EP 1 012 002 B1 discloses a cover designed in the manner of a suitcase-like hollow body for a vehicle storage compartment. At least one transportation container is an integral part of the hollow body and is designed to accommodate loads between at a suitcase lid and a suitcase base. The suitcase lid can be pivoted relative to the suitcase base. The suitcase lid or the suitcase base can have at least one pocket designed to accommodate at least one battery or at least one rechargeable battery. The suitcase lid can be locked in different pivot positions in relation to the suitcase base.

European patent application EP 2 033 846 A2 discloses a storage compartment for a vehicle. The storage compartment has a housing and an upper edge region of the housing forms a support surface for a loading floor cover that extends at least from the housing to a storage compartment edge associated with a rear section. In this way, storage compartments that are fitted with batteries, for example, can be utilized more effectively for accommodating further loads.

German laid-open specification DE 10 2009 009 150 A1 discloses a motor vehicle having a trunk compartment and a trunk compartment floor beneath which an energy storage system is arranged. The energy storage system comprises one or more batteries arranged in a concealed manner below an external battery housing.

The object of the invention is to improve the comfort, performance and/or the range of a motor vehicle, in particular a hybrid vehicle or of an electric vehicle that has an electric motor.

### SUMMARY OF THE INVENTION

The invention relates to a battery system having at least one battery for driving an electric motor of a hybrid vehicle or of an electric vehicle. The battery system comprises an exchangeable component battery system. The entire battery system preferably is not exchangeable. Rather, only the component battery system is exchangeable. The exchangeable component battery system can be used, for example, to reduce or increase the range of the hybrid vehicle or of the electric vehicle. A driver of the hybrid vehicle or electric vehicle can consider and make a decision as to whether he requires a relatively high or relatively low battery capacity before a journey or during a journey. Thus, new energy can be provided in the hybrid vehicle or electric vehicle in a simple manner repeatedly, quickly and without protracted charging merely by changing the component battery system. In the case of a relatively low energy requirement, the component battery system also can be omitted entirely to reduce the weight and therefore the power/weight ratio of the hybrid vehicle or of the electric vehicle and to increase the size of the storage compartment of the hybrid vehicle or of the electric vehicle. Furthermore, energy storage means with different power/energy characteristics can be used in the component battery system. Therefore, the E-system can be equipped to sometimes be directed at power and to sometimes be directed at energy capacity.

The exchangeable component battery system preferably comprises at least one exchangeable auxiliary battery in addition to a supply battery. The supply battery functions to supply electrical power to the electric vehicle or hybrid vehicle. The auxiliary battery can be inserted selectively into or removed from the electric vehicle or hybrid vehicle. The electric vehicle or hybrid vehicle has a greater range when the auxiliary battery is inserted. The electric vehicle or hybrid vehicle is lighter and can be moved more dynamically and/or have a greater amount of usable trunk space when the auxiliary battery is not inserted.

The invention also relates to a motor vehicle having an electric motor that can be driven by the above-described battery system. The motor vehicle preferably is a hybrid vehicle or an electric vehicle.

The motor vehicle may have a trunk compartment delimited at the bottom by a movable trunk compartment floor, and may have an electric power source beneath the trunk compartment floor. An accommodation space for at least one auxiliary battery of the above-described battery system preferably is provided beneath the trunk compartment floor. “At the bottom” means toward the ground when the motor vehicle is on the ground.

The trunk compartment floor of the motor vehicle preferably can be adjusted vertically to change the size of the accommodation space in accordance with requirements. The trunk compartment floor is, for example, guided between two extreme positions in a movable manner.

The trunk compartment floor of the motor vehicle preferably is arranged right at the bottom in a loading position to provide the maximum possible trunk compartment volume. The accommodation space is reduced to zero in the loading position of the trunk compartment floor and an additional battery is not arranged in the accommodation space.

The trunk compartment floor of the motor vehicle preferably can be moved up to a battery position so that the accommodation space accommodates the auxiliary battery. The accommodation space containing the auxiliary battery is partitioned off from the trunk compartment by the trunk compartment floor.

The trunk compartment floor of the motor vehicle may be configured to be adjusted manually to at least two different vertical positions. More particularly, the trunk compartment floor preferably can be fixed in its loading position and in its battery position in a simple manner. If required, the trunk compartment floor also can be fixed in intermediate positions to accommodate, for example, auxiliary batteries of a different size.

The trunk compartment floor of the motor vehicle may be adjusted vertically by motor, such as an electric motor, and particularly an actuating motor, possibly using a suitable gear mechanism.

The accommodation space of the motor vehicle may be accessible from below to insert, remove or exchange the auxiliary battery. To this end, the accommodation space can have an opening at the bottom and the auxiliary battery may fit through the opening. The opening can be closed, for example, by a removable or pivotable cover.

Further advantages, features and details of the invention can be gathered from the following description in which an exemplary embodiment is described in detail with reference to the drawings.

### BRIEF DESCRIPTION OF THE DRAWINGS

FIG. 1 is a highly simplified illustration of the motor vehicle having a trunk compartment and a trunk compartment floor in a loading position.

FIG. 2 is the same view as in FIG. 1 with the trunk compartment floor in a battery position.

### DETAILED DESCRIPTION OF THE PREFERRED EMBODIMENT

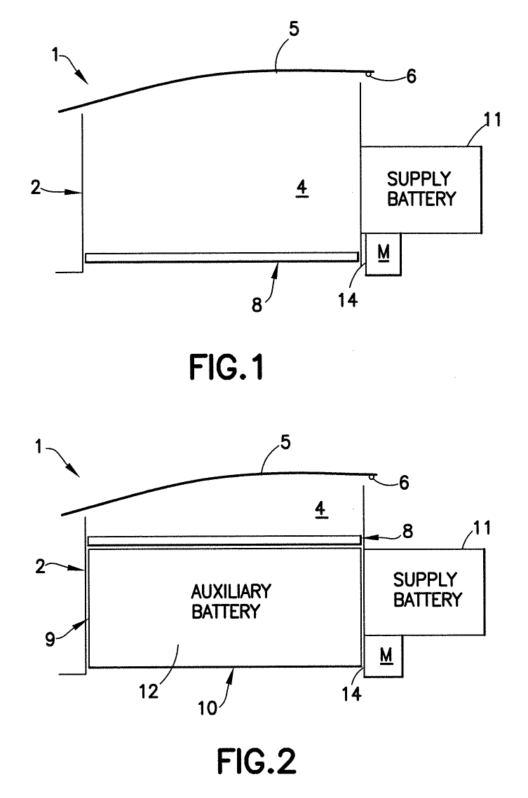

FIGS. 1 and 2 illustrate, in a highly simplified manner, a motor vehicle 1 having a vehicle body 2. The vehicle body 2 comprises a trunk compartment 4 that is closed by a trunk compartment lid 5. The trunk compartment lid 5 can pivot about a pivot axis 6 to open the trunk compartment 4.

The trunk compartment 4 is delimited by a trunk compartment floor 8 that can be adjusted in height toward the bottom and away from the trunk compartment lid 5. Vertical adjustment of the trunk compartment floor 8 changes the distance of the trunk compartment lid 5 from said trunk compartment floor 8, and therefore changes the volume of the trunk compartment 4.

FIG. 1 shows the trunk compartment floor 8 arranged right at a loading position in which the trunk compartment floor 8 is arranged a maximum distance from the trunk compartment lid 5. Therefore, the trunk compartment 4 is at its maximum volume.

FIG. 2 shows the trunk compartment floor 8 moved up toward the trunk compartment lid 5 and into a battery position. As a result, the volume of the trunk compartment 4 is reduced considerably. At the same time, an accommodation space 9 is created beneath the trunk compartment floor 8. The accommodation space functions to accommodate a component battery system 10. The component battery system 10 comprises an auxiliary battery 12 arranged in the accommodation space 9 beneath the trunk compartment floor 8.

The component battery system 10 is part of a battery system that comprises a supply battery 11 that supplies electrical power to an electric motor 1, which preferably is part of a hybrid vehicle or an electric vehicle.

The supply battery 11 of the battery system preferably is installed permanently in the motor vehicle 1. In contrast, the auxiliary battery 12 of the component battery system 10 can be removed from the accommodation space 9 or exchanged for another auxiliary battery. When the auxiliary battery 12 is removed from the accommodation space 9, the trunk compartment floor 8 can be lowered to its loading position, as illustrated in FIG. 1.

The accommodation space 9 preferably is accessible from below for the purpose of inserting or removing the auxiliary battery 12. To this end, a suitable opening 14 is provided in the vehicle body 2, below the trunk compartment floor 8, the size of the opening 14 is matched to the size of the auxiliary battery 12. The opening 14 can be closed by a cover 16. Therefore, a large portion of the trunk compartment 4 can be used either as a storage space, as shown in FIG. 1, or as an accommodation space 9 for an auxiliary battery 12, as shown in FIG. 2.

A motor M optionally is provided for moving the trunk compartment floor 8 at least between the loading position of FIG. 1 and the battery position of FIG. 2.

What is claimed is:

1. A battery system having at least one battery for driving an electric motor of a hybrid vehicle or of an electric vehicle, characterized in that the battery system comprises an exchangeable component battery system.

2. The battery system of claim 1, wherein the exchangeable component battery system comprises at least one exchangeable auxiliary battery and a supply battery.

3. A motor vehicle having an electric motor that can be driven by a battery system, the battery system comprising a supply battery and at least one exchangeable auxiliary battery.

4. A motor vehicle comprising: an electric power source having a supply battery and at least on auxiliary battery; a trunk compartment having a bottom delimited by a movable trunk compartment floor, an accommodation space provided beneath the trunk compartment floor and configured for accommodating the at least one auxiliary battery.

5. The motor vehicle of claim 4, wherein the trunk compartment floor is vertically adjustable to change dimensions of the accommodation space in accordance with whether the auxiliary battery is required.

6. The motor vehicle of claim 5, wherein the trunk compartment floor is moveable to a loading position defining a maximum possible trunk compartment volume.

7. The motor vehicle of claim 6, wherein the trunk compartment floor is moveable up to a battery position defining the accommodation space that accommodates the auxiliary battery.

8. The motor vehicle of claims 7, wherein the trunk compartment floor is manually adjustable vertically.

9. The motor vehicle of claim 7, further comprising a motor for vertically adjusting positions of the trunk compartment floor.

10. The motor vehicle of claim 4, further comprising an opening at a lower part of the accommodation space for accessing the accommodation space from below to insert, remove or exchange the auxiliary battery.
